(19) United States
(12) Patent Application Publication
(10) Pub. No.: US 2012/0056745 A1
(43) Pub. Date: Mar. 8, 2012

(54) Notification control apparatus, electronic apparatus, timepiece apparatus and program

(76) Inventors: Eriko Noguchi, Chiba-shi (JP); Keisuke Isubata, Chiba-shi (JP); Kazuo Kato, Chiba-shi (JP); Yoshinori Sugai, Chiba-shi (JP); Tomohiro Ihashi, Chiba-shi (JP); Hisao Nakamura, Chiba-shi (JP); Satoshi Sakai, Chiba-shi (JP)

(21) Appl. No.: 13/199,494

(22) Filed: Aug. 31, 2011

(30) Foreign Application Priority Data
Sep. 6, 2010 (JP) 2010-199220
Jun. 14, 2011 (JP) 2011-132474

(51) Int. Cl. G08B 23/00; G08B 17/12; G08B 21/00

(52) U.S. Cl. 340/573.1; 340/540; 340/600

(57) ABSTRACT

The invention is intended to prevent sunburn of a user. A CPU prompts the user to perform sunburn preventing treatment after an elapse of a first period, and notifies the elapse of a second period after the elapse of the second period from the prompt.

### BACKGROUND OF THE INVENTION

1. Technical Field

The present invention relates to a notification control apparatus, an electronic apparatus, a timepiece apparatus, and a program.

2. Description of the Related Art

In recent years, prevention from sunburn by ultraviolet light draws increasing attention and an apparatus configured to aid measure to prevent the sunburn is known.

In JP-A-5-149785, an apparatus configured to measure the amount of ultraviolet light and display a threshold duration which may cause sunburn under an environment of being irradiated with ultraviolet light such as being outdoors or sea bathing in advance is described.

In JP-A-2006-071582, a watch having an ultraviolet light sensor, which is an apparatus displaying the amount of ultraviolet light of the moment or after a preset period and estimating a sunburn phenomenon on the basis of selective input of a mode selection switch for selecting indoors or outdoors or a climate selection switch, is described.

In the technologies of the related art described in JP-A-5-149785 and JP-A-2006-071582, a period (threshold period) which may cause a user to get sunburn according to the amount of ultraviolet light that the user is irradiated with is calculated. However, the sun-block cream has a nature of coming off with perspiration or the like after coating and is decreased in its effect. Therefore, in the related art, the duration by which the effect of the prevention of sunburn is weakened cannot be calculated accurately, so that the user may disadvantageously get sunburn.

### SUMMARY OF THE INVENTION

It is an aspect of the application to provide a notification control apparatus and program which can prevent a user from getting sunburn.

(1) According to another aspect of the application, there is provided a notification control apparatus comprising a notification controller configured to exercise control to prompt a user to perform a sunburn preventing treatment after an elapse of a first period and, after a second period has elapsed from the notification, notify the elapse of the second period.

(2) Preferably, the notification controller starts counting of the first period when there is an input indicating the fact that the sunburn preventing treatment has finished before the elapse of the second period.

(3) Preferably, a total period of the first period and the second period is a period until the preset sunburn preventing treatment loses its effect and the second period corresponds to a period spent for the sunburn preventing treatment.

(4) The notification control apparatus according to the application includes an ultraviolet light detection controller configured to cause the intensity of ultraviolet light to be measured when the time indicated by a time and day measuring unit is within a preset range, and is characterized in that the notification controller controls to prompt the user to perform the sunburn preventing treatment when the intensity caused by the ultraviolet light detection controller to be measured is equal to or higher than a threshold value.

(5) Preferably, the time within the preset range is a time when the user goes outdoors.

(6) Preferably, the notification controller prompts the user to perform the sunburn preventing treatment at a specified starting time and starts the measurement of the first period after the notification.

(7) The notification control apparatus according to the application includes an input controller configured to accept a first input indicating that the user has gone out to a place in the sun and a second input indicating that the user has entered a place out of the sun, and is characterized in that the notification controller prompts the user to perform the sunburn preventing treatment when the time elapsed from a moment when the input controller receives the second input is longer than the first period at the moment when the input controller receives the first input.

(8) The notification control apparatus in the application preferably includes the ultraviolet light detection controller configured to cause the intensity of ultraviolet light to be measured when the first period has elapsed, and is characterized in that the notification controller determines a mode of prompting the user to perform the sunburn preventing treatment on the basis of the intensity of ultraviolet light measured by the ultraviolet light detection controller.

(9) The notification control apparatus according to the application preferably includes the ultraviolet light detection controller configured to cause an integrated quantity of ultraviolet light obtained by integrating the intensity of ultraviolet light until the first period is elapsed to be measured, and is characterized in that the notification controller determines the mode of prompting the user to perform the sunburn preventing treatment on the basis of the integrated quantity of ultraviolet light measured by the ultraviolet light detection controller.

(10) The notification control apparatus according to the application preferably includes the ultraviolet light detection controller configured to cause the integrated quantity of ultraviolet light obtained by integrating the intensity of ultraviolet light until the first period is elapsed to be measured, and is characterized in that the notification controller sets the first period on the basis of the integrated quantity of ultraviolet light measured by the ultraviolet light detection controller.

(11) The notification control apparatus according to the application includes: the ultraviolet detection controller configured to cause the intensity of ultraviolet light to be measured; and a user detection controller configured to cause a state of activity of the user to be detected when the intensity caused by the ultraviolet light detection controller to be measured is equal to or higher than the threshold value, and is characterized in that the notification controller shortens the first period on the basis of the detected state of activity.

(12) According to another aspect of the application, there is provided an electronic apparatus including the notification control apparatus described above. The electronic apparatus may be a pedometer.

(13) According to another aspect of the application, there is provided a timepiece apparatus including the notification control apparatus described above.

(14) According to another aspect of the application, there is provided a program for causing a computer of the notification control apparatus to execute a procedure for exercising control for prompting a user to perform a sunburn preventing treatment after the elapse of a first period and notifying the elapse of the second period again after the elapse of the second period from the prompt.

### ADVANTAGE OF THE INVENTION

According to the invention, the user is prevented from getting sunburned.

### BRIEF DESCRIPTION OF THE DRAWINGS

FIG. 1 is an external appearance view of a timepiece apparatus according to an embodiment of the invention;

FIG. 2 is a schematic block diagram showing a configuration of the timepiece apparatus according to the embodiment of the invention;

FIG. 3 is a flowchart showing an operation of a notification control apparatus according to a first embodiment of the invention;

FIG. 4 is a flowchart showing an example of an operation of a CPU according to a second embodiment of the invention;

FIG. 5 is a flowchart showing an example of an operation of the CPU according to a third embodiment of the invention;

FIG. 6 is a flowchart showing an example of an operation of the CPU according to a fourth embodiment of the invention;

FIG. 7 is a flowchart showing an example of an indoor processing operation of the CPU according to the fourth embodiment;

FIG. 8 is a flowchart showing an example of an outdoor processing operation of the CPU according to the fourth embodiment;

FIG. 9 is a table showing an example of data for calculating a sunburn prevention period according to the first to fourth embodiments of the invention;

FIG. 10 is a flowchart showing an example of an operation of a timepiece apparatus according to a fifth embodiment of the invention;

FIG. 11 is a flowchart showing another example of an operation of the timepiece apparatus according to the fifth embodiment;

FIG. 12 is a flowchart showing another example of an operation of the timepiece apparatus according to the fifth embodiment;

FIG. 13 is a schematic block diagram showing a configuration of a timepiece apparatus according to a sixth embodiment of the invention; and

FIG. 14 is a flowchart showing an example of an operation of the CPU according to the sixth embodiment.

### DESCRIPTION OF THE PREFERRED EMBODIMENTS

### First Embodiment

Referring now to the drawings, a first embodiment will be described.

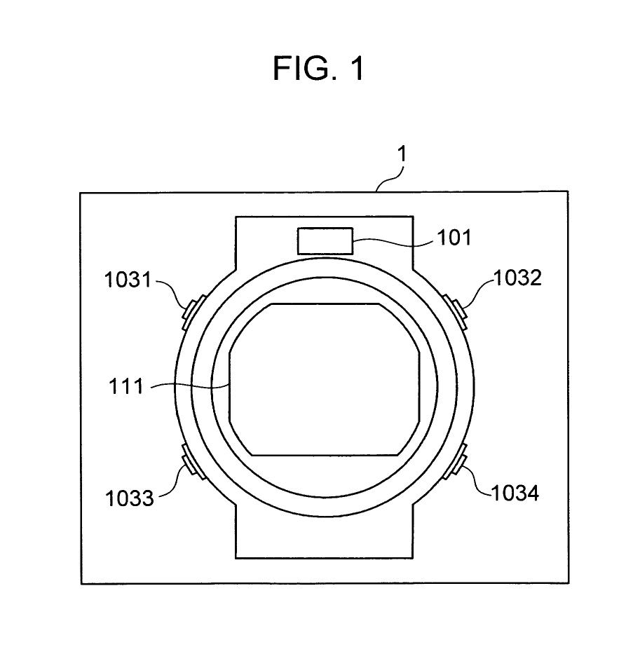

FIG. 1 is an external appearance view showing an external appearance of a timepiece apparatus 1 according to the first embodiment. In the illustrated example, the timepiece apparatus 1 includes an ultraviolet sensor 101, switches 1031-1034, and a display 111.

The ultraviolet sensor 101 is provided above the display 111, and measures an intensity of ultraviolet light entering a light-receiving surface. The display 111 is a liquid crystal display or a digital display panel and displays information to be notified to a user.

The switches 1031-1034 are provided on side surface of a main body, and receive inputs from the user by being pressed. More specifically, the switch 1031 is used for selecting ON and OFF of the power source. The switch 1032 is used for entering response from the user with respect to the notification. The switch 1033 is used for selecting one of an indoor mode and an outdoor mode. The switch 1034 is used for achieving a state which causes the user to update the time (an activation time updating mode). In the activation time updating mode, the switches 1031-1034 are used for inputs for updating an activating time.

The sensor 101 or the switches 1031-1034 may be provided at other positions on the timepiece apparatus 1. A plurality of the ultraviolet sensor 101 may be provided on the timepiece apparatus 1. The timepiece apparatus 1 may be provided with a speaker which outputs voices or a light-emitting unit configured to emit light.

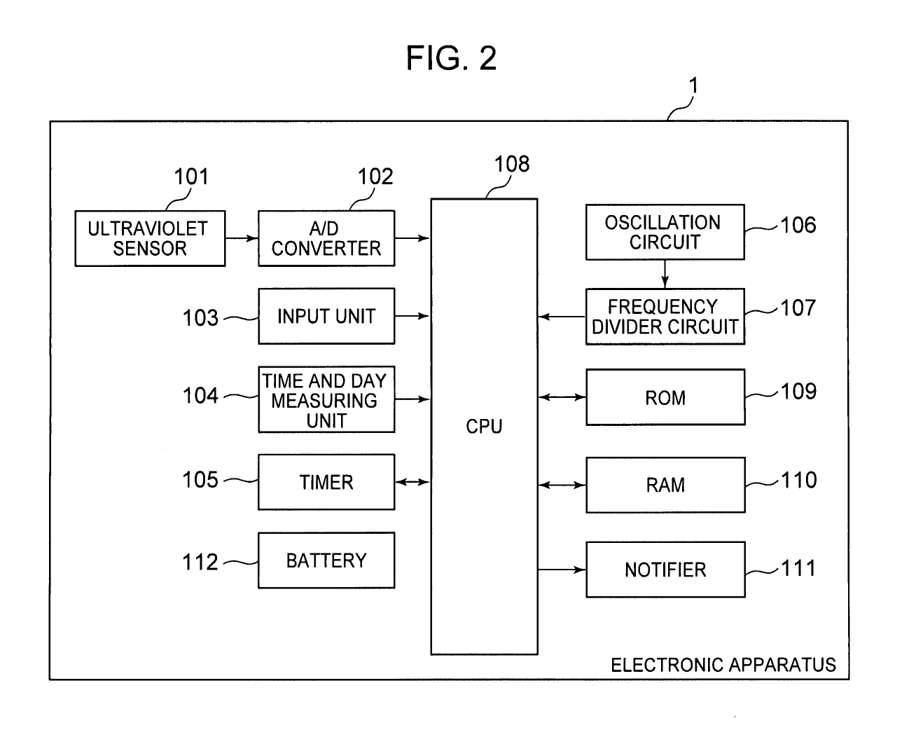

FIG. 2 is a block diagram showing a configuration of the timepiece apparatus 1 according to the first embodiment. In the illustrated example, the timepiece apparatus 1 includes the ultraviolet sensor 101, an A/D converter 102, an input unit 103, a time and day measuring unit 104, a timer 105, an oscillation circuit 106, a frequency divider circuit 107, a CPU 108, a read-only memory (ROM) 109, a random access memory (RAM) 110, a notifier 111 and a battery 112.

The ultraviolet sensor 101 is configured to measure the intensity of ultraviolet light entering the light-receiving surface, and outputs a signal indicating the measured intensity to the A/D converter 102.

The A/D converter 102 converts the signal received from the ultraviolet sensor 101 from analogue to digital. The A/D converter 102 outputs the digital signal after conversion to the CPU 108.

The input unit 103 includes the switches 1031-1034 in FIG. 1, and receives inputs from the outside. The input unit 103 outputs signals according to the inputs to the CPU 108. For example, when the switch 1032 is pressed, the input unit 103 outputs a signal (care-end signal) which indicates that a sunburn preventing treatment has ended to the CPU 108.

The time and day measuring unit 104 measures date and time, and outputs date information indicating the measured date and time information indicating the time to the CPU 108.

The timer 105 receives an input of the time to be clocked (referred to as “timer period”) from the CPU 108, so that the timer period is set. The timer 105 starts measurement of the timer period upon receipt of an input of a start-trigger signal from the CPU 108, and determines whether or not the timer period has elapsed. When it is determined that the timer period has elapsed as a result of determination, the timer 105 outputs a signal indicating HIGH (H) to the CPU 108. In contrast, when it is determined that the timer period has not elapsed, the timer 105 outputs a signal indicating LOW (L) to the CPU 108.

The oscillation circuit 106 acquires a signal received from an oscillator such as a quartz oscillator or the like and outputs the acquired signal to the frequency divider circuit 107.

A value is set to the frequency divider circuit 107 in advance so as to match a range of clock frequency at which the CPU 108 is operated, so that the frequency divider circuit 107 generates divided clock signals (reduced in frequency) using an input from the oscillation circuit 106. More specifically, the frequency divider circuit 107 counts an oscillation signal received from the oscillation circuit 106 using a counter circuit and, when the countered value reaches a preset value, outputs a digital pulse to the CPU 108. The frequency divider circuit 107 is capable of changing the period of a digital pulse (clock period) by changing the preset value.

The CPU 108 performs a calculating process synchronously with the output of the clock signal from the frequency divider circuit 107. For example, the CPU 108 activates the ultraviolet sensor 101 and the A/D converter 102. Also, the CPU 108 sets a first period (referred to as “sunburn preventing period”), a second period (“care period”), a third period (referred to as “re-warning period”) to the timer 105 on the basis of information from the input unit 103, the ultraviolet sensor 101, the time and day measuring unit 104, the ROM 109 or the RAM 110 and causes the timer 105 to clock these times. After the elapse of the time clocked by the timer 105, the CPU 108 causes the display 111 to output a notification prompting the user to perform the sunburn preventing treatment, a notification indicating that the care period has elapsed, a notification indicating that the re-warning period has elapsed, and so on.

The ROM 109 stores programs or data that the CPU 108 uses. The ROM 109 outputs data to the CPU 108 according to a requirement from the CPU 108. The RAM 110 stores data entered from the CPU 108 temporarily. The RAM 110 outputs the data stored in the RAM 110 to the CPU 108 according to the requirement from the CPU 108.

The notifier 111 (the display 111 in the example shown in FIG. 1) receives information to be notified to the user from the CPU 108, and notifies the information to be notified to the user by an indication. The notifier 111 may be a light-emitting unit or a speaker, and in these cases, the notifier 111 outputs light or sounds. The notifier 111 may be a vibrator which causes the timepiece apparatus 1 to vibrate.

The battery 112 supplies a driving power to respective parts of the timepiece apparatus 1.

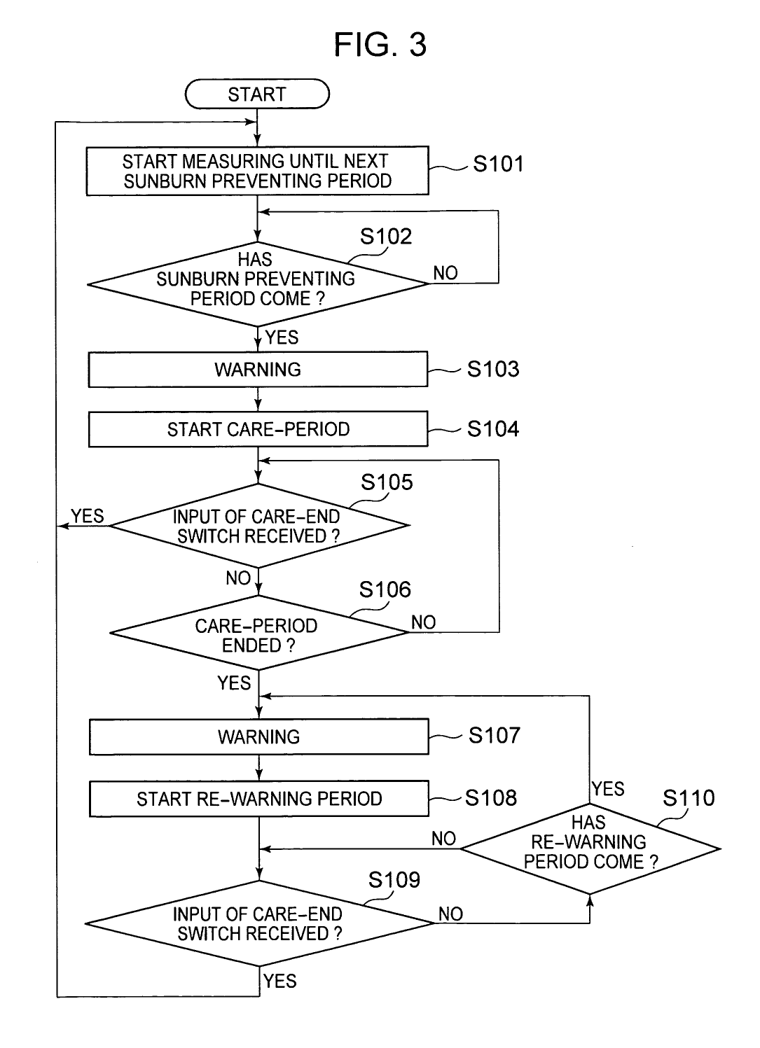

Subsequently, an operation of the CPU 108 (notification control apparatus) in the first embodiment will be described. FIG. 3 is a flowchart showing an example of the operation of the notification control apparatus 1 in the first embodiment.

(Step S101) The CPU 108 sets the value of the sunburn preventing period (first period) to the timer 105. The CPU 108 outputs a start-trigger signal to the timer 105. Accordingly, the timer 105 starts counting of the preset sunburn preventing period. Subsequently, the procedure goes to Step S102. The sunburn preventing period (for example, 1 hour) may be the one specified in a program recorded in the ROM 109 in advance, or may be the one entered by the user via the input unit 103 and recorded by the CPU 108 in the RAM 110.

(Step S102) The CPU 108 determines whether or not the sunburn preventing period, which has started to count in Step S101, has elapsed by determining whether or not the output from the timer 105 is HIGH (H). When it is determined that the sunburn preventing period has elapsed (Yes), the procedure goes to Step S103. In contrast, when it is determined that the sunburn preventing period has not elapsed (No), the procedure goes back to the process in Step S102.

(Step S103) The CPU 108 sends an output to cause the notifier 111 to display a notification which urging the user to perform the sunburn preventing treatment, and upon receipt of an input from the CPU 108, the notifier 111 prompts the user to perform the sunburn preventing treatment. Then, the procedure goes to Step S104.

(Step S104) The CPU 108 sets a value of the care period (second period) to the timer 105. The CPU 108 outputs the start-trigger signal to the timer 105. Accordingly, the timer 105 starts counting of the preset care period. Subsequently, the procedure goes to Step S105. The care period (for example, 30 minutes) is a period that the user spends for the sunburn preventing treatment. The care period may be the one specified in the program recorded in the ROM 109 in advance, or may be the one entered by the user via the input unit 103 and recorded by the CPU 108 in the RAM 110.

(Step S105) The input unit 103 determines whether or not the switch 1032 is pressed. When it is determined that the switch 1032 is pressed, the input unit 103 outputs a signal (referred to as a care-ended signal) to the CPU 108, and when it is not determined that the switch 1032 is pressed, the input unit 103 does not output the care-ended signal. When there is an input of the care-ended signal (Yes), the procedure goes back to the process in Step S101, and when there is no input of the care-ended signal (No), the procedure goes to the process in Step S106.

(Step S106) The CPU 108 determines whether or not the care period, which has started to count in Step S104, has elapsed by determining whether or not the output from the timer 105 is HIGH (H). When it is determined that the care period has elapsed (Yes), the procedure goes to Step S107. In contrast, when it is determined that the care period has not elapsed (No), the procedure goes back to the process in Step S105.

(Step S107) The CPU 108 sends an output to cause the notifier 111 to notify the user that the care period has elapsed, and upon receipt of an input from the CPU 108, the notifier 111 sends a notification saying that the care period has elapsed. Subsequently, the procedure goes to the process in Step S104.

(Step S108) The CPU 108 sets the value of the re-warning period (third period) to the timer 105. The CPU 108 outputs the start-trigger signal to the timer 105. Accordingly, the timer 105 starts counting of the preset re-warning period.

(Step S109) The input unit 103 determines whether or not the switch 1032 is pressed. When it is determined that the switch 1032 is pressed, the input unit 103 outputs a signal (referred to as the care-ended signal) to the CPU 108, and when it is not determined that the switch 1032 is pressed, the input unit 103 does not output the care-ended signal. When there is the input of the care-ended signal (Yes), the procedure goes back to the process in Step S101, and when there is no input of the care-ended signal (No), the procedure goes to the process in Step S110.

(Step S110) The CPU 108 determines whether or not the re-warning period which has started in Step S108 has elapsed by determining whether or not the output from the timer 105 is HIGH (H). When it is determined that the re-warning period has elapsed (Yes), the procedure goes to Step S107. In contrast, when it is determined that the re-warning period has not elapsed (No), the procedure goes back to the process in Step S109.

With the operation shown in FIG. 3, the timepiece apparatus 1 is used as shown below.

The user enters an input to start counting the sunburn preventing period to the timepiece apparatus 1. The timepiece apparatus 1 sets the preset sunburn preventing period and performs the counting. When the sunburn preventing period has elapsed, the timepiece apparatus 1 notifies as such by the notifier 111. Simultaneously, the timepiece apparatus 1 starts counting the care period. When the care period has elapsed, the timepiece apparatus 1 notifies the elapse of the care period by the notifier 111.

When the sunburn preventing treatment is ended, the user presses the switch 1032. When there is an input of the care-ended signal from the input unit 103, the timepiece apparatus 1 sets the timer 105 for the sunburn preventing period, and immediately starts counting of a new sunburn preventing period.

The total period of the sunburn preventing period and the care period is set to be the sum of the period when the preset sunburn preventing treatment loses its effectiveness, and the time spent for the sunburn preventing treatment.

When the user ends the care within the re-warning period, the CPU 108 immediately restarts the sunburn preventing period. When the there is no input to the input unit 103, the elapse of the re-warning period is waited and the elapse of the care period is notified by the notifier 111 again, and the notifier 111 repeats the notification of the elapse of the care period until the user ends the sunburn preventing treatment.

As described above, according to the embodiment, the CPU 108 exercises control of prompting the user to perform the sunburn preventing treatment after the sunburn preventing treatment time has elapsed and, after the care period has elapsed from the notification which prompts the user to perform the sunburn preventing treatment, notifying the user of the elapse of the care period. In other words, the timepiece apparatus 1 prompts the user to perform the sunburn preventing treatment after the sunburn preventing treatment time has elapsed and, after the care period has elapsed, notifies the user of the elapse of the care period.

Accordingly, in the first embodiment, the timepiece apparatus 1 sets the time when sun-block cream or cosmetics for reducing the amount of penetration of the ultraviolet light may come off in advance, notifies the user when the set time (the sunburn preventing period) has elapsed and, after the care period has elapsed, notifies the elapse of the care period when the care period has elapsed. Since coming off of the cream or the like depends on the time, the timepiece apparatus 1 can notify the coming-off of the cream to the user, so that the sunburn of the user can be prevented.

According to the first embodiment, when there is an input indicating that the sunburn preventing treatment has ended before the care period has elapsed, the CPU 108 causes the timer 105 to start counting the sunburn preventing period. Accordingly, in the first embodiment, since the timepiece apparatus 1 starts counting of the sunburn preventing period immediately after having ended the sunburn preventing treatment, the next sunburn preventing period can be counted accurately.

According to the first embodiment, the total period of the sunburn preventing period and the care period is the sum of the time when the preset sunburn preventing treatment loses its effect, and the time spent for the sunburn preventing treatment. Accordingly, the timepiece apparatus 1 notifies the sunburn preventing period taking the time spent for the sunburn preventing treatment into consideration. Therefore, the user can achieve further reliable sunburn preventing measure.

### Second Embodiment

Referring now to the drawings, a second embodiment of the invention will be described. A configuration of a timepiece apparatus according to the second embodiment (referred to as timepiece apparatus 2) is the same as the external appearance (FIG. 1) and the configuration (FIG. 2) of the timepiece apparatus 1 in the first embodiment except for the operation of the CPU 108. Therefore, description other than the CPU 108 will be omitted.

In this embodiment, the timepiece apparatus 2 acquires the current time from the time and day measuring unit 104, and if the acquired time is included within a time range set in advance, for example, from eight o'clock in the morning to 8 o'clock in the afternoon, the timepiece apparatus 2 starts measurement of the intensity of ultraviolet light and if the acquired time is not included within the above-described time range, the timepiece apparatus 2 does not perform measurement of the intensity of ultraviolet light. The timepiece apparatus 2 also measures the intensity by the ultraviolet sensor 101, and outputs the intensity of ultraviolet light by the A/D converter 102. The CPU 108 determines whether or not the measurement of the intensity of ultraviolet light again is performed after a preset ultraviolet line re-measuring period (fourth period) has elapsed if a measured value of the intensity of the ultraviolet light supplied from the A/D converter 102 is smaller than a preset threshold value. The CPU 108 prompts the user to perform the sunburn preventing treatment shown in Claim 1 and notifies the user of the elapse of the care period repeatedly within a preset time range.

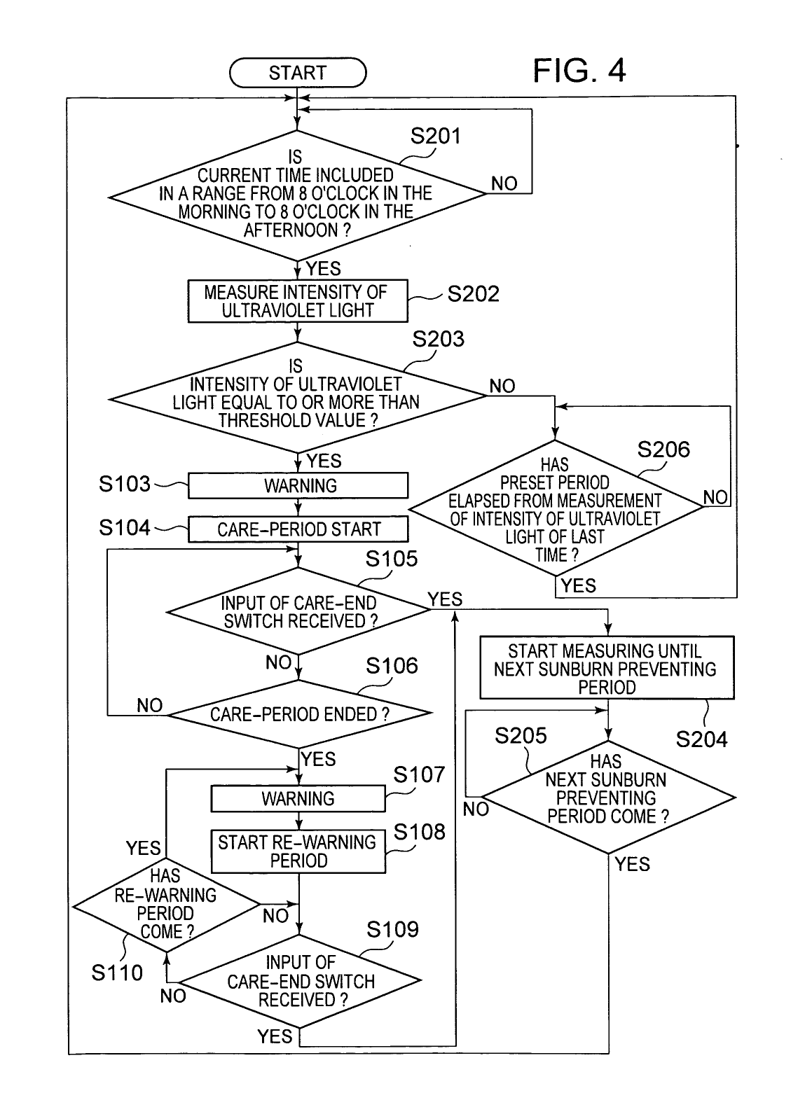

Subsequently, an operation of the CPU 108 (notification control apparatus) in the second embodiment will be described. FIG. 4 is a flowchart showing an example of an operation of the timepiece apparatus 2 in the second embodiment. Since the respective processes from Step S103 to Step S110 are basically the same as the respective processes from the Step S103 to Step S110 in the first embodiment (FIG. 3), description will be omitted. However, the operation of the timepiece apparatus 2 is different from that in the first embodiment (FIG. 3) in that the procedure goes to Step S204 when the result of determination in Step S105 is (Yes) and in that the procedure goes to Step S204 when the result of determination in Step S109 is (Yes).

(Step S201) The CPU 108 determines whether or not the current time acquired by the time and day measuring unit 104 is within the preset time range. The time within the preset time range is the time when the user is outdoors, which is, for example, from 8 o'clock in the morning to 8 o'clock in the afternoon. If it is within the preset time range (Yes), the procedure goes to the process in Step S202. In contrast, when it is out of the preset time range (No), the procedure goes back to the process in Step S201. The preset time range may be the one specified in a program recorded in the ROM 109 in advance, or may be the one entered by the user via the input unit 103 and recorded by the CPU 108 in the RAM 110.

(Step S202) The CPU 108 (ultraviolet light detection controller) activates the ultraviolet sensor 101 and the A/D converter 102. The ultraviolet sensor 101 is configured to measure the intensity of ultraviolet light, and outputs a value indicating the measured intensity to the A/D converter 102. The A/D converter 102 converts the value received from the ultraviolet sensor 101 into a digital signal. The power sources of the ultraviolet sensor 101 and the A/D converter 102 are turned ON only during the process in Step S202 when driven from the CPU 108, and are turned OFF in other cases. Accordingly, in the timepiece apparatus 2, power consumptions of the ultraviolet sensor 101 and the A/D converter 102 can be reduced. Subsequently, the CPU 108 sets the value of the ultraviolet light re-measuring period to the timer 105. The CPU 108 outputs the start-trigger signal to the timer 105. Accordingly, the timer 105 starts counting of the preset ultraviolet light re-measuring period. Subsequently, the procedure goes to the process in Step S203.

(Step S203) The CPU 108 acquires the digital signal indicating the intensity of ultraviolet light from the A/D converter 102, and compares with the threshold value of the intensity of ultraviolet light recorded in the ROM 109. If the current intensity of the ultraviolet light is equal to or higher than the threshold value of the intensity of ultraviolet light recorded in the ROM 109 (Yes), the procedure goes to the process in Step S103. In contrast, if the current intensity of the ultraviolet light is smaller than the threshold value of the intensity of ultraviolet light recorded in the ROM 109 (No), the procedure goes to the process in Step S206.

(Step S204) The CPU 108 sets the value of the sunburn preventing period to the timer 105. The CPU 108 outputs the start-trigger signal to the timer 105. Accordingly, the timer 105 starts counting of the preset sunburn preventing period. Subsequently, the procedure goes to Step S213. The sunburn preventing period may be the one specified in the program recorded in the ROM 109 in advance, or may be the one entered by the user via the input unit 103 and recorded by the CPU 108 in the RAM 110.

(Step S205) The CPU 108 determines whether or not the sunburn preventing period, which has started to count in Step S204, has elapsed by determining whether or not the output from the timer 105 is HIGH (H). When it is determined that the sunburn preventing period has elapsed (Yes), the procedure goes back to Step S201. In contrast, when it is determined that the sunburn preventing period has not elapsed (No), the procedure goes back to the process in Step S205.

(Step S206) The CPU 108 determines whether or not the ultraviolet light re-measuring period, which has started to count in Step S202, has elapsed. When it is determined that the ultraviolet light re-measuring period has elapsed (Yes), the procedure goes to Step S201. In contrast, when it is determined that the ultraviolet light re-measuring period has not elapsed (No), the procedure goes back to the process in Step S206.

With the operation shown in FIG. 4, the timepiece apparatus 2 is used as shown below.

When the time indicated by the time and day measuring unit is in a preset range, the timepiece apparatus 2 causes the ultraviolet light detection controller to measure the intensity of ultraviolet light and, when the value is equal to or higher than the preset threshold value, prompts the user to perform the sunburn preventing treatment. The preset time range may be the time at which the user goes outdoors. When the intensity of ultraviolet light is equal to or lower than a certain value, the notification is not performed, and measurement of the intensity of ultraviolet light is repeated every time when the re-warning period has elapsed.

As described above, according to the second embodiment, when the time indicated by the time and day measuring unit 104 is within the preset range, the CPU 108 causes the ultraviolet sensor 101 to measure the intensity of ultraviolet light. When the intensity measured by the ultraviolet sensor 101 is equal to or higher than the threshold value, the CPU 108 exercises control to prompt the user to perform the sunburn preventing treatment. In other words, when the time indicated by the time and day measuring unit 104 is within the preset range, the ultraviolet sensor 101 measures the intensity of ultraviolet light.

Accordingly, in the second embodiment, the timepiece apparatus 2 attempts the detection of the ultraviolet light only in the time band when being outdoors, and prompts the sunburn preventing treatment when the intensity of the ultraviolet light is equal to or higher than the preset threshold value so that the sunburn is prevented. During the period other than that described above, the sunburn preventing treatment is not prompted and, in addition, when the intensity of ultraviolet light does not reach the threshold value, the notification to prompt the sunburn preventing treatment is not performed. Therefore, the timepiece apparatus 2 contributes to reduction of battery consumption, and does not send the notification while the user stays indoors.

Also, according to the second embodiment, the time within the preset range corresponds to the time when the user goes outdoors. Accordingly, the notification to prompt the user to perform the sunburn preventing treatment reliably can be performed while the user is outdoors.

### Third Embodiment

Referring now to the drawings, a third embodiment of the invention will be described. A configuration of a timepiece apparatus in the third embodiment (referred to as timepiece apparatus 3) is the same as that in the second embodiment.

The characteristic points of the third embodiment is in that the timepiece apparatus 3 acquires the current time from the time and day measuring unit 104 and, when the current time reaches a starting time of the sunburn preventing period preset using the input unit 103, for example, 8 o'clock in the morning, prompts the user to perform the sunburn preventing treatment, and then starts the sunburn preventing period. The preset time may be the time when the user goes outdoors.

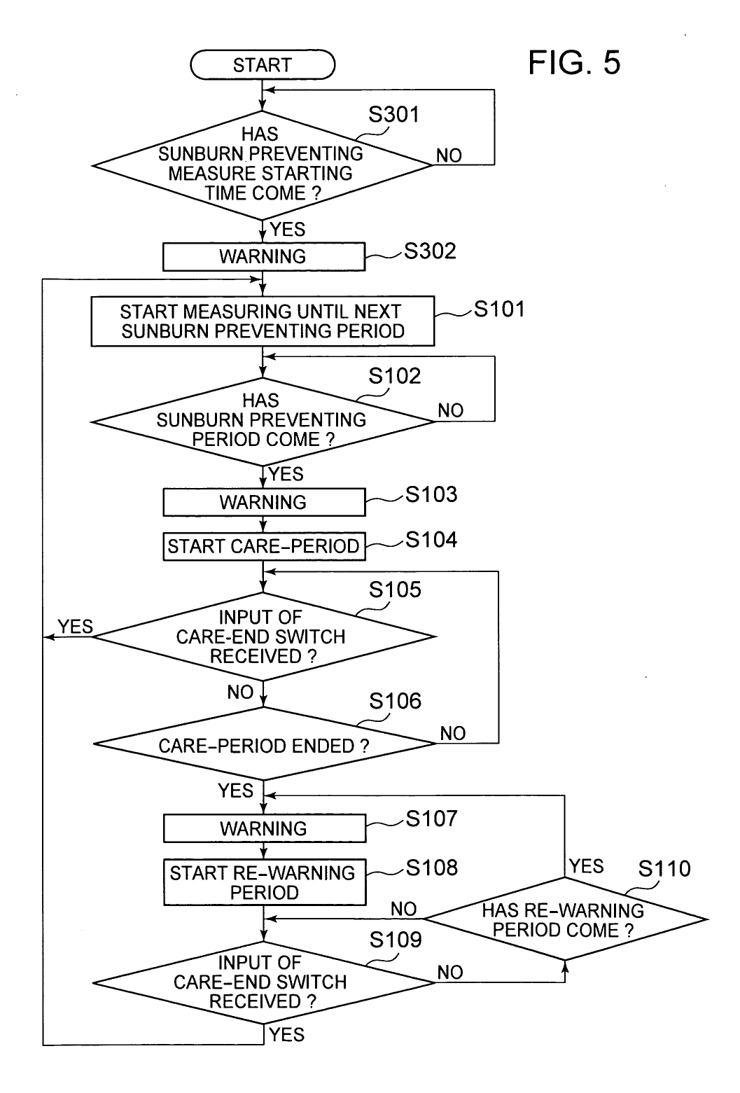

Subsequently, an operation of the CPU 108 (notification control apparatus) in the third embodiment will be described. FIG. 5 is a flowchart showing an example of an operation of the timepiece apparatus 1 in the third embodiment. Since the respective processes from Step S101 to step S110 are basically the same as the respective processes from the Step S101 to step S110 in the first embodiment (FIG. 3), description will be omitted. However, the operation of the timepiece apparatus 3 is different from that in the first embodiment (FIG. 3) in that the procedure goes to Step S101 when the result of determination in Step S105 is (Yes) and in that the procedure goes to Step S101 when the result of determination in Step S109 is (Yes).

(Step S301) The CPU 108 acquires the current time from the time and day measuring unit 104, and determines whether or not the starting time of the sunburn preventing period specified in advance comes around. When the starting time of the sunburn preventing period comes around (Yes), the procedure goes to Step S302. In contrast, when the starting time of the sunburn preventing period does not come around (No), the procedure goes back to the process in Step S301.

(Step S302) The CPU 108 sends a command to cause the notifier 111 to display a notification which urges the user to perform the sunburn preventing treatment, and upon receipt of the command from the CPU 108, the notifier 111 prompts the user to perform the sunburn preventing treatment. Then, the procedure goes to Step S101.

With the operation shown in FIG. 5, the timepiece apparatus 3 is used as shown below.

The timepiece apparatus 3 prompts the user to perform the sunburn preventing treatment when the preset starting time comes around, and then performs the same operation as in the first embodiment.

As described above, according to the embodiment, the CPU 108 exercises control of prompting the user to perform the sunburn preventing treatment at the specified starting time and, after the notification which prompts the user to perform the sunburn preventing treatment, the timer 105 starts the measurement of the sunburn preventing period.

Accordingly, the timepiece apparatus 3 prompts the user to take the sunburn preventing measure at the fixed time every day. For example, if the time to go outdoors is set to the starting time, the timepiece apparatus 3 prompts the user to take the sunburn preventing measure when the user goes out, and hence the user can make sure to take the sunburn preventing measure.

### Fourth Embodiment

Referring now to the drawings, a fourth embodiment of the invention will be described. A configuration of a timepiece apparatus in the fourth embodiment (referred to as timepiece apparatus 4) is the same as the configuration of the timepiece apparatus 2 in the second embodiment.

When the input unit 103 senses information indicating whether the user is now outdoors and the CPU 108 determines that the user has entered indoors, the CPU 108 acquires the current time from the time and day measuring unit 104, and records the acquired time to the RAM 110. Subsequently, when the input unit 103 senses that the user goes outdoors, and the CPU 108 determines that the user goes outdoors, the CPU 108 acquires the current time from the time and day measuring unit 104, calculates the difference between the time recorded in the RAM 110 and the current time, and determines an indoor staying period (fourth period).

When it is determined that the indoor staying period is longer than the sunburn preventing period, the CPU 108 prompts the user to perform the sunburn preventing treatment using the notifier 111. Even when it is determined that the indoor staying period is shorter than the sunburn preventing period, if it is determined that the elapsed time from the time when the last sunburn preventing measure has been taken is longer than the sunburn preventing period, the CPU 108 prompts the user to perform the sunburn preventing treatment. The information indicating whether or not the user is currently outdoors may be entered by the user using the switch 1033 or may be a signal sensed by the ultraviolet sensor 101 and converted from analogue to digital by the A/D converter 102.

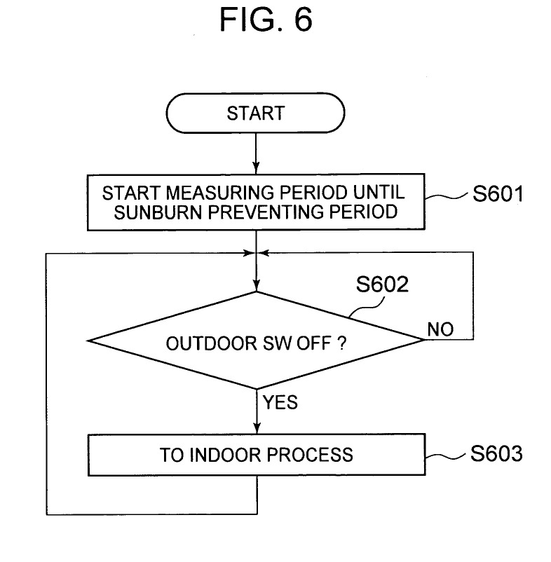

Subsequently, the operation of the timepiece apparatus 4 in the fourth embodiment will be described. FIG. 6 is a flowchart showing an example of the operation to start the timepiece apparatus 4 in the fourth embodiment.

(Step S601) The CPU 108 sets a value of the sunburn preventing period to the timer 105. The CPU 108 outputs the start-trigger signal to the timer 105. Accordingly, the timer 105 starts counting of the preset sunburn preventing period. Subsequently, the procedure goes to Step S602. The sunburn preventing period may be the one specified in the program recorded in the ROM 109 in advance, or may be the one entered by the user via the input unit 103 and recorded by the CPU 108 in the RAM 110.

(Step S602) The CPU 108 monitors the input from the input unit 103, and if the fact that the user enters the indoors is detected (Yes), the procedure goes to the process in Step S603 and, when the fact that the user enters the indoors is not detected (No), the procedure goes back to the process in Step S602.

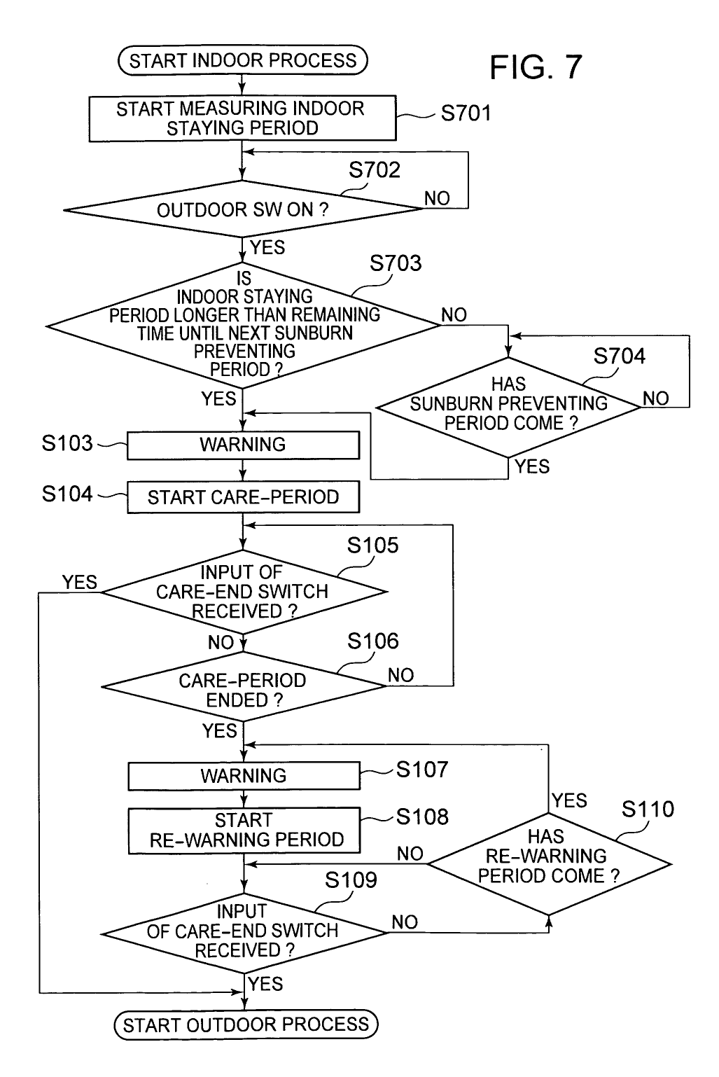

(Step S603) The procedure goes to the start of an indoor process shown in FIG. 7.

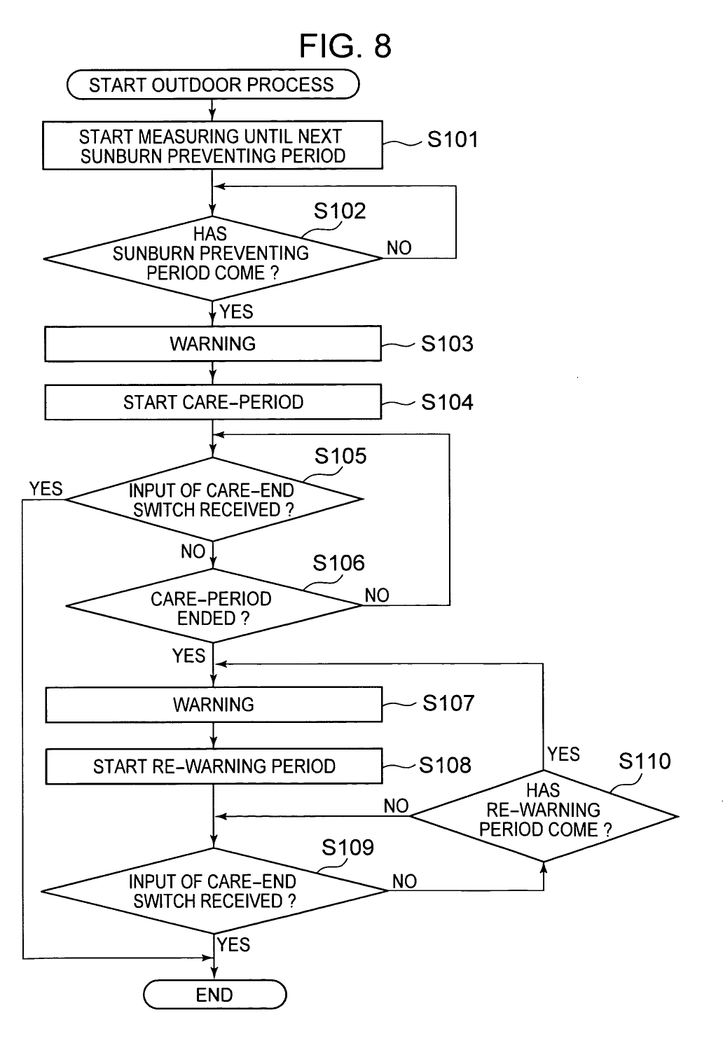

FIG. 7 is a flowchart showing an example of the operation of the timepiece apparatus 4 in the fourth embodiment. Since the respective processes from Step S103 to step S110 are basically the same as the respective processes from the Step S103 to step S110 in the first embodiment (FIG. 3), description will be omitted. However, the operation of the timepiece apparatus 4 is different from that in the first embodiment (FIG. 3) in that the procedure goes to End (the start of an outdoor process shown in FIG. 8) when the result of determination in Step S105 is (Yes) and in that the procedure goes to End (the start of the outdoor process shown in FIG. 8) when the result of determination in Step S109 is (Yes).

(Step S701) The CPU 108 inputs the current time (referred to as going-indoors time) from the time and day measuring unit 104, and records the same in the RAM 110.

(Step S702) The CPU 108 monitors the input from the input unit 103, and if there is an input indicating the fact that the user has gone outdoors (Yes), the procedure goes to the process in Step S703 and, when there is no input indicating the fact that the user goes outdoors (No), the procedure goes back to the process in Step S702.

(Step S703) The CPU 108 acquires the current time from the time and day measuring unit 104, and calculates the time difference with the “going-indoor time” recorded in the RAM 110 in the Step S701. If the indoor staying period is longer than the sunburn preventing period (Yes), the procedure goes to the process in Step S103. In contrast, when the indoor staying period is not longer than the sunburn preventing period (No), the procedure goes to the process in Step S704.

(Step S704) The CPU 108 determines whether or not the sunburn preventing period, which has started to count in Step S601 in FIG. 6, has elapsed by determining whether or not the output from the timer 105 is HIGH (H). When it is determined that the sunburn preventing period has elapsed (Yes), the procedure goes to Step S103. In contrast, when it is determined that the sunburn preventing period has not elapsed (No), the procedure goes back to the process in Step S704.

FIG. 8 is a flowchart showing an example of the operation of the timepiece apparatus 4 in the fourth embodiment. Since the respective processes from Step S101 to step S110 are basically the same as the respective processes from the Step S101 to step S110 in the first embodiment (FIG. 3), description will be omitted. However, the operation of the timepiece apparatus 4 is different from that in the first embodiment (FIG. 3) in that the procedure goes to End when the result of determination in Step S105 is (Yes) and in that the procedure goes to End when the result of determination in Step S109 is (Yes).

With the operation shown in FIGS. 6, 7, and 8, the timepiece apparatus 4 is used as shown below.

The timepiece apparatus 4 calculates the elapsed time since the user enters a place out of the sun when the user goes out to a place in the sun and, if the elapsed time since the user enters the place out of the sun is longer than the sunburn preventing period, prompts the user to perform the sunburn preventing treatment. In contrast, when the elapsed time since the user goes into the place out of the sun is not longer than the sunburn preventing period, the CPU 108 waits until the elapsed time from the time when the last sunburn preventing measure has performed exceeds the sunburn preventing period, and prompts the user to perform the sunburn preventing treatment.

As described above, according to the fourth embodiment, the input unit 103 accepts that there are the input indicating the fact that the user has gone out to the place in the sun and the fact that the user has entered the place out of the sun. When the input unit 103 receives the input indicating the fact that the user has gone out to the place in the sun, the CPU 108 determines whether the elapsed time since the input unit 103 receives the input indicating the fact that the user has entered the place out of the sun is equal to or longer than the sunburn preventing period. When the CPU 108 determines that the elapsed time since the input unit 103 accepts the input indicating the fact that the user has gone into the place out of the sun is equal to or longer than the sunburn preventing period, the CPU 108 causes the notifier 111 to prompt the user to perform the sunburn preventing treatment.

Accordingly, in the fourth embodiment, the timepiece apparatus 4 does not prompt the user to take the sunburn preventing measure while the user stays in the place out of the sun even when the sunburn preventing period is elapsed. Also, when the user goes out to the place in the sun thereafter, the timepiece apparatus 4 notifies the user of the fact that the time when the sunburn preventing treatment is needed has elapsed.

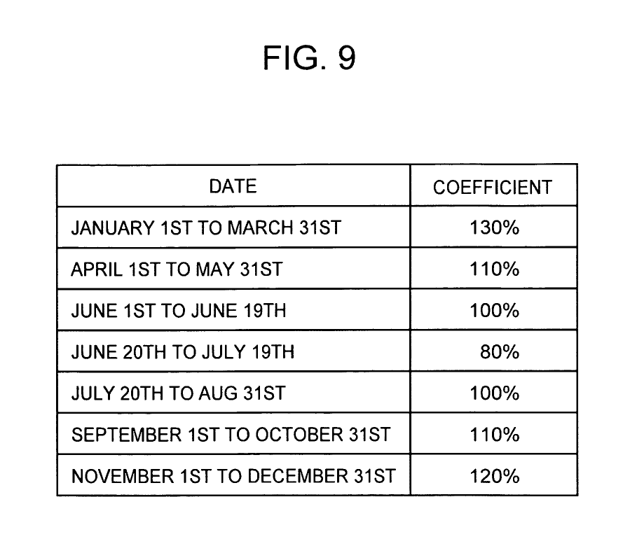

In the timepiece apparatuses 1 to 4 according to Embodiments 1 to 4, the sunburn preventing period in which the intensities of the ultraviolet light or the amount of perspiration estimated from one date to another are taken into consideration may be calculated and stored in the ROM 109 in advance. The CPU 108 may vary the sunburn preventing period from one date to another using a table of the sunburn preventing period in FIG. 9.

FIG. 9 is a schematic drawing showing an example of a table roughly indicating the sunburn preventing periods in the respective embodiments. In FIG. 9, the sunburn preventing period table includes columns of items, namely, date and coefficient. Here, the coefficient is a coefficient by which the sunburn preventing period is multiplied by the CPU 108.

For example, in FIG. 9, when the data is “June 1st to June 19th” and “July 20th to August 31st”, the coefficient is “100%”. Also, in FIG. 9, for example, when the date is “June 20th to July 19th”, the coefficient is “80%”. Here, the coefficient “80%” of “June 20 to July 19th” is a smaller value in comparison with the coefficients of other dates. In other words, in the timepiece apparatuses 1 to 4, in the period “June 20th to July 19th”, the sunburn preventing period is shorter than those in other periods. Accordingly, the sunburn preventing period can be shortened in the period of “June 20th to July 19th”, that is, in the rainy season. Therefore, in the timepiece apparatuses 1 to 4, during the rainy season in which the humidity level is high and hence the sun-block cream comes off earlier, the elapse of the sunburn preventing period can be notified in short intervals accordingly. In the same manner, in FIG. 9, when the date is “January 1st to March 31th”, the coefficient is “130%”. Here, the coefficient “130%” of “January 1st to March 31th” is a larger value in comparison with the coefficients of other dates. In other words, in the timepiece apparatuses 1 to 4, the period “January 1st to March 31th”, the sunburn preventing period is longer than those in other periods. Therefore, in the timepiece apparatuses 1 to 4, during the period in which the humidity level is low and hence the sun-block cream comes off slowly, the fact that the sunburn preventing period has elapsed can be notified in long intervals accordingly.

This table shows the coefficients for finding the sunburn preventing period from one date to another with reference to the sunburn preventing period (for example, one hour) in the period of July 20th to August 31th. For example, “the coefficient in the rainy season from June 20th to July 20th is “80%”” means that the sunburn preventing period is 80% (48 minutes) of the reference period considering that the sun-block cream comes off early because the humidity level is high. In the same manner, during the winter from January 1st to March 31th, the sunburn preventing period is 130% (78 minutes) of the reference period considering that the sun-block cream comes off slower than the reference because amount of perspiration is small.

### Fifth Embodiment

Referring now to the drawings, a fifth embodiment of the invention will be described. A configuration of a timepiece apparatus in the fifth embodiment (referred to as timepiece apparatus 5) is the same as the configuration of the timepiece apparatus 2 in the second embodiment.

Referring now to FIG. 2, the configuration of the timepiece apparatus 5 will be described.

The CPU 108 receives an input of a signal indicating HIGH (H) from the timer 105, and then receives a digital signal after conversion from the A/D converter 102. The signal received from the timer indicates the elapse of the sunburn preventing period as described above. The digital signal received from the A/D converter 102 indicates the intensity of ultraviolet light measured by the ultraviolet sensor 101.

The CPU 108 determines whether or not the received intensity of ultraviolet light indicated by the received digital signal is equal to or higher than the threshold value of the preset intensity of the ultraviolet light. If the CPU 108 determines that the received intensity of ultraviolet light indicated by the received digital signal is equal to or higher than the threshold value of the preset intensity of the ultraviolet light, the CPU 108 outputs a signal indicating usage of a sound to the notifier 111. If the CPU 108 determines that the received intensity of ultraviolet light indicated by the received digital signal is lower than the threshold value of the preset intensity of the ultraviolet light, the CPU 108 outputs a signal indicating usage of an image to the notifier 111. In this manner, the higher the intensity of ultraviolet light, the more effective signal the CPU 108 outputs to the notifier 111 for prompting the user to perform the sunburn preventing treatment.

In this embodiment, the CPU 108 may determine whether or not the integrated quantity of ultraviolet light is equal to or higher than the preset threshold value of the integrated quantity of ultraviolet light instead of determining whether or not the received intensity of ultraviolet light indicated by the received digital signal is equal to or higher than the threshold value of the preset intensity of the ultraviolet light. In order to measure the integrated quantity of ultraviolet light, the CPU 108 integrates the intensity of ultraviolet light indicated by the digital signal received from the A/D converter 102 from the start of measurement of the sunburn preventing period to the elapse of the time. Then, the CPU 108 determines whether or not the integrated quantity of ultraviolet light indicated by the measured digital signal is equal to or larger than the threshold value of the preset integrated quantity of ultraviolet light, and selects one of the signal indicating the usage of the sound and the signal indicating the usage of the image as a signal to be supplied to the notifier 111.

In the fifth embodiment, the CPU 108 may determine the sunburn preventing period during which the integrated quantity of ultraviolet light is to be measured on the basis of the measured integrated quantity of ultraviolet light. For example, the CPU 108 determines whether the measured integrated quantity of ultraviolet light is equal to or larger than the threshold value of the preset integrated quantity of ultraviolet light. When the CPU 108 determines that the measured integrated quantity of ultraviolet light is equal to or larger than the threshold value of the preset integrated quantity of ultraviolet light, the CPU 108 selects a first sunburn preventing period. When the CPU 108 determines that the measured integrated quantity of ultraviolet light is smaller than the threshold value of the preset integrated quantity of ultraviolet light, the CPU 108 selects a second sunburn preventing period. The CPU 108 integrates the intensity of ultraviolet light described above until the selected sunburn preventing period is elapsed to measure the integrated quantity of ultraviolet light. The second sunburn preventing period is set to be shorter than the first sunburn preventing period.

The notifier 111 includes a plurality of means for prompting the user to perform the sunburn preventing treatment. For example, the notifier 111 includes a sound reproducer configured to perform the notification using a sound and a screen display configured to perform the notification using an image. The sound reproducer of the notifier 111 reproduces, for example, a beep sound such as a buzzer. The screen display displays for example, characters or pictograms which prompts the user to perform the sunburn preventing treatment.

More specifically, in the notifier 111, the sound reproducer outputs a sound which prompts the user to perform the sunburn preventing treatment upon receipt of the signal indicating the usage of the sound from the CPU 108. In the notifier 111, the screen display displays an image which prompts the user to perform the sunburn preventing treatment upon receipt of the signal indicating the usage of the image from the CPU 108. The notifier 111 is not limited to the screen display and the sound reproducer, and may need only a configuration which performs the notification for prompting the user to perform the sunburn preventing treatment in other modes (for example, a vibrator).

Subsequently, an example of the operation of the timepiece apparatus 5 in the fifth embodiment will be described.

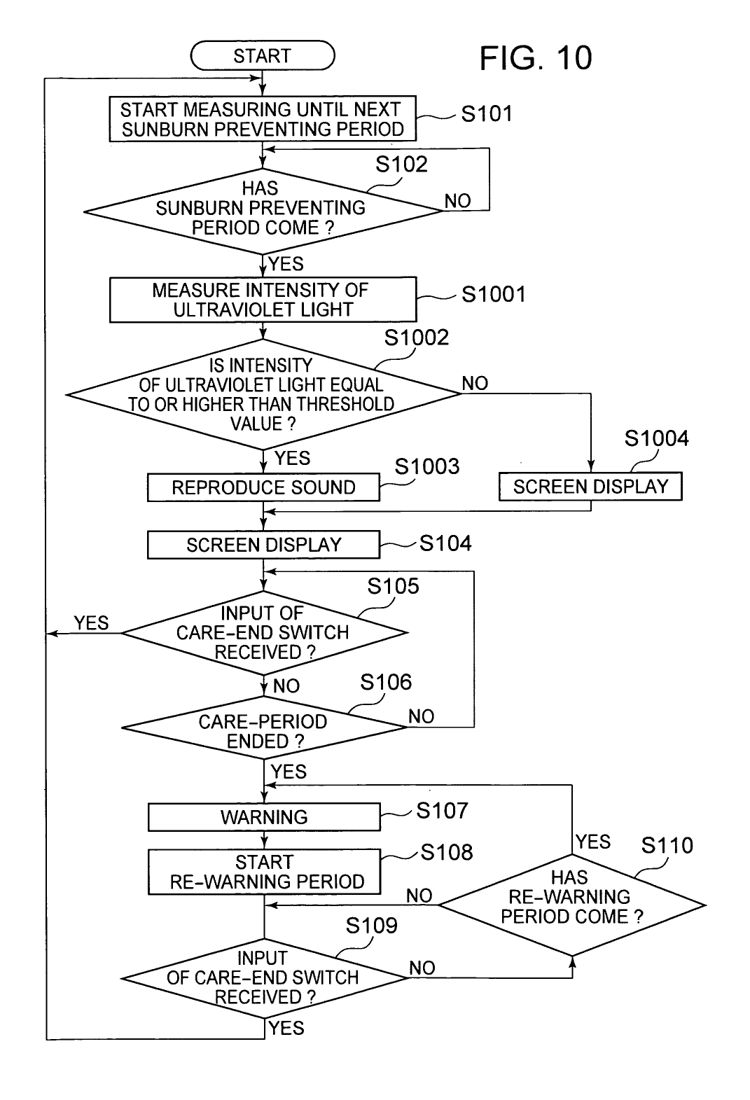

FIG. 10 is a flowchart showing an example of the operation of the timepiece apparatus 5 in the fifth embodiment. The example of the operation of the timepiece apparatus shown in FIG. 10 is different from the example of the operation shown in FIG. 3 in points of including Steps S1001 to S1004 instead of the Step S103, performing the Step S1001 after the Step S102, and performing the Step S104 after the Step S1003 or Step S1004. Other steps are the same as the example of the operation shown in FIG. 3. Hereinafter, Steps S1001 to S1004 will be described.

(Step S1001) The CPU 108 (notification control apparatus) receives an input of a digital signal after conversion from the A/D converter 102. The input of the digital signal indicates the intensity of ultraviolet light measured by the ultraviolet sensor 101. Subsequently, the procedure goes to Step S1002.

(Step S1002) The CPU 108 determines whether or not the intensity of the ultraviolet light indicated by the received digital signal is equal to or higher than the threshold value of the preset intensity of the ultraviolet light. If the CPU 108 determines that the intensity of the ultraviolet light indicated by the received digital signal is equal to or higher than the threshold value of the preset intensity of the ultraviolet light (Yes), the CPU 108 outputs the signal indicating the usage of the sound to the notifier 111, and the procedure goes to Step S1003. If the CPU 108 determines that the intensity of the ultraviolet light indicated by the received digital signal is lower than the threshold value of the preset intensity of the ultraviolet light (No), the CPU 108 outputs the signal indicating the usage of the image to the notifier 111, and the procedure goes to Step S1004.

(Step S1003) In the notifier 111, the sound reproducer outputs a sound which prompts the user to perform the sunburn preventing treatment upon receipt of the signal indicating the usage of the sound from the CPU 108. Subsequently, the procedure goes to Step S104.

(Step S1004) In the notifier 111, the screen display displays an image which prompts the user to perform the sunburn preventing treatment upon receipt of the signal indicating the usage of the image from the CPU 108.

Subsequently, the procedure goes to Step S104.

Subsequently, another example of the operation of the timepiece apparatus 5 in the fifth embodiment will be described.

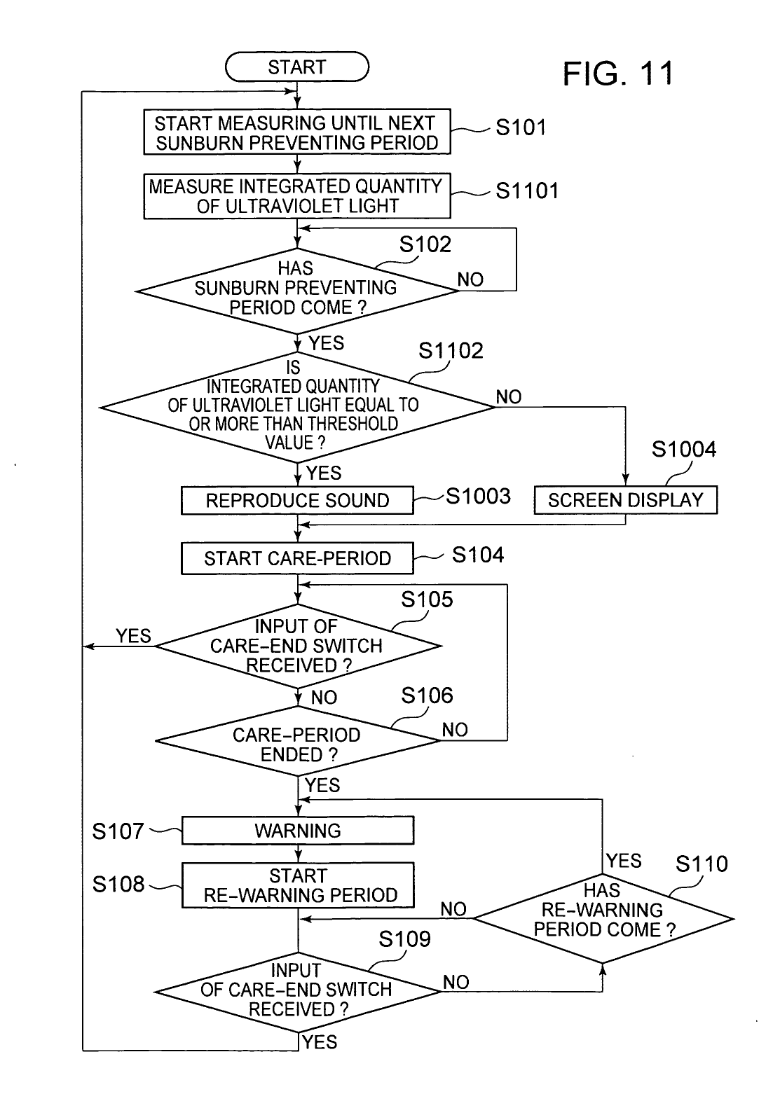

FIG. 11 is a flowchart showing another example of the operation of the timepiece apparatus 5 in the fifth embodiment. The example shown in FIG. 11 is different from the example of the operation shown in FIG. 10 in points of including Steps S1101 and S1102 instead of the Steps S1001 and S1002, performing the Step S1101 after the Step S101, performing the Step S102 after the Step S1101, and performing the Step S1102 after the Step S102. Other steps are the same as the example of the operation shown in FIG. 10. Hereinafter, Steps S1101 and S1102 will be described.

(Step S1101) The CPU 108 (notification control apparatus) integrates the intensity of ultraviolet light indicated by the input of the digital signal received from the A/D converter 102 from the start of measurement of the sunburn preventing period to the elapse of the time to measure the integrated quantity of ultraviolet light. Subsequently, the procedure goes to Step S102.

(Step S1102) The CPU 108 determines whether or not the measured integrated quantity of ultraviolet light is equal to or larger than the threshold value of the preset integrated quantity of ultraviolet light. If the CPU 108 determines that the integrated quantity of ultraviolet light indicated by the received digital signal is equal to or larger than the threshold value of the preset integrated quantity of ultraviolet light (Yes), the CPU 108 outputs a signal indicating the usage of the sound to the notifier 111, and the procedure goes to Step S1003. If the CPU 108 determines that the integrated quantity of ultraviolet light indicated by the received digital signal is smaller than the threshold value of the preset integrated quantity of ultraviolet light (No), the CPU 108 outputs the signal indicating the usage of the image to the notifier 111, and the procedure goes to Step S1004.

Accordingly, in the fifth embodiment, the timepiece apparatus 5 is capable of presenting information which prompts the user to take the sunburn preventing measure in the mode according to the intensity of ultraviolet light or the integrated quantity of ultraviolet light. The stronger the intensity of ultraviolet light or the larger the integrated quantity of ultraviolet light, the more the probability of awareness of the information which the timepiece apparatus 5 prompts the user to take the sunburn preventing measure increases.

Subsequently, another example of the operation of the timepiece apparatus 5 in the fifth embodiment will be described.

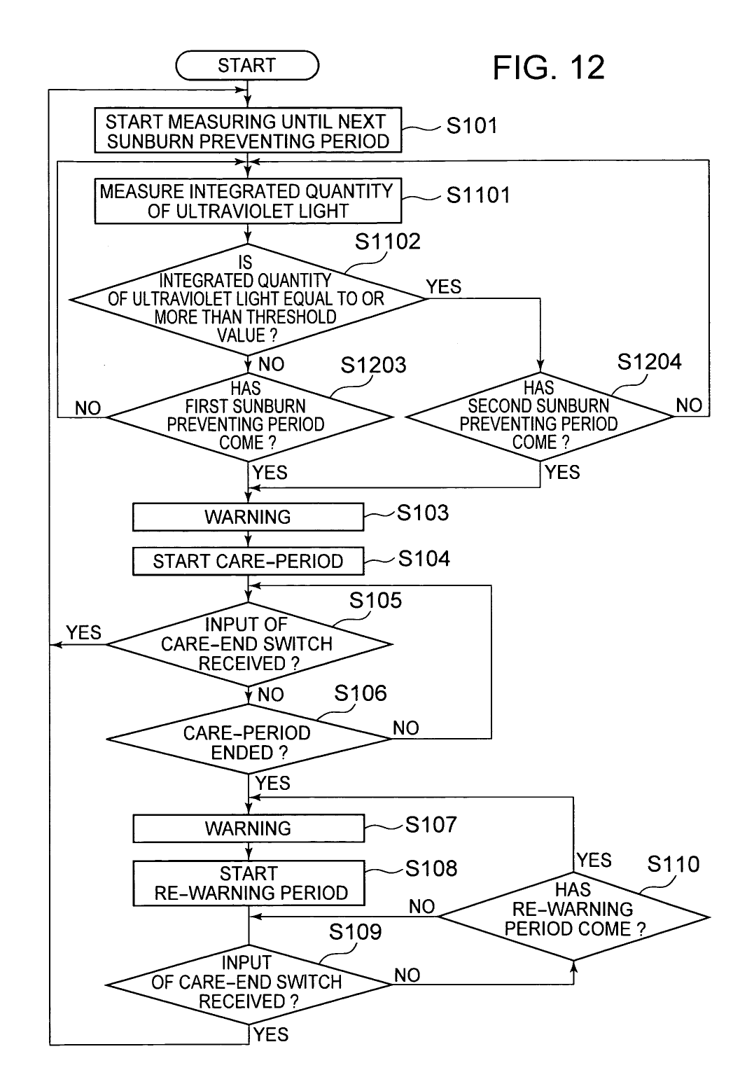

FIG. 12 is a flowchart showing another example of the operation of the timepiece apparatus 5 in the fifth embodiment. The example shown in FIG. 12 is different from the example of the operation shown in FIG. 11 in points of including Steps S1203 and S1204 instead of the Steps S1003 and S1004, performing the Step S1101 after the Step S101, the Step S1203 (No), and the Step S1204 (No), performing the Step S1102 after the Step S1101, and performing the Step S1203 or the step S1204 after the Step S1102. Other steps are the same as the example of the operation shown in FIG. 11. Hereinafter, Steps S1102, S1203 and S1204 will be described.

(Step S1102) The CPU 108 (notification control apparatus) determines whether or not the measured integrated quantity of ultraviolet light is equal to or larger than the threshold value of the preset integrated quantity of ultraviolet light. If the CPU 108 determines that the integrated quantity of ultraviolet light indicated by the received digital signal is equal to or larger than the threshold value of the preset integrated quantity of ultraviolet light (Yes), the procedure goes to Step S1204. If the CPU 108 determines that the integrated quantity of ultraviolet light indicated by the received digital signal is smaller than the threshold value of the preset integrated quantity of ultraviolet light (No), the procedure goes to Step S1203.

(Step S1203) The CPU 108 determines whether or not the first sunburn preventing period has elapsed from the start of the measurement of the integrated quantity of ultraviolet light. When the CPU 108 determines that the first sunburn preventing period has elapsed from the start of the measurement of the integrated quantity of ultraviolet light (Yes), the procedure goes to Step S103. When the CPU 108 determines that the first sunburn preventing period has not elapsed from the start of the measurement of the integrated quantity of ultraviolet light (No), the procedure goes to Step S1101.

(Step S1204) The CPU 108 determines whether or not the second sunburn preventing period has elapsed from the start of the measurement of the integrated quantity of ultraviolet light. However, the second sunburn preventing period is shorter than the first sunburn preventing period. When the CPU 108 determines that the second sunburn preventing period has elapsed from the start of the measurement of the integrated quantity of ultraviolet light (Yes), the procedure goes to Step S103. When the CPU 108 determines that the second sunburn preventing period has not elapsed from the start of the measurement of the integrated quantity of ultraviolet light (No), the procedure goes to Step S1101.

Accordingly, in the fifth embodiment, the larger the integrated quantity of ultraviolet light, the shorter the measuring period required for measuring the integrated quantity of ultraviolet light could be, so that the information which prompts the user to take the sunburn preventing measure quickly can be presented to the user.

### Sixth Embodiment

Referring now to the drawings, a sixth embodiment of the invention will be described.

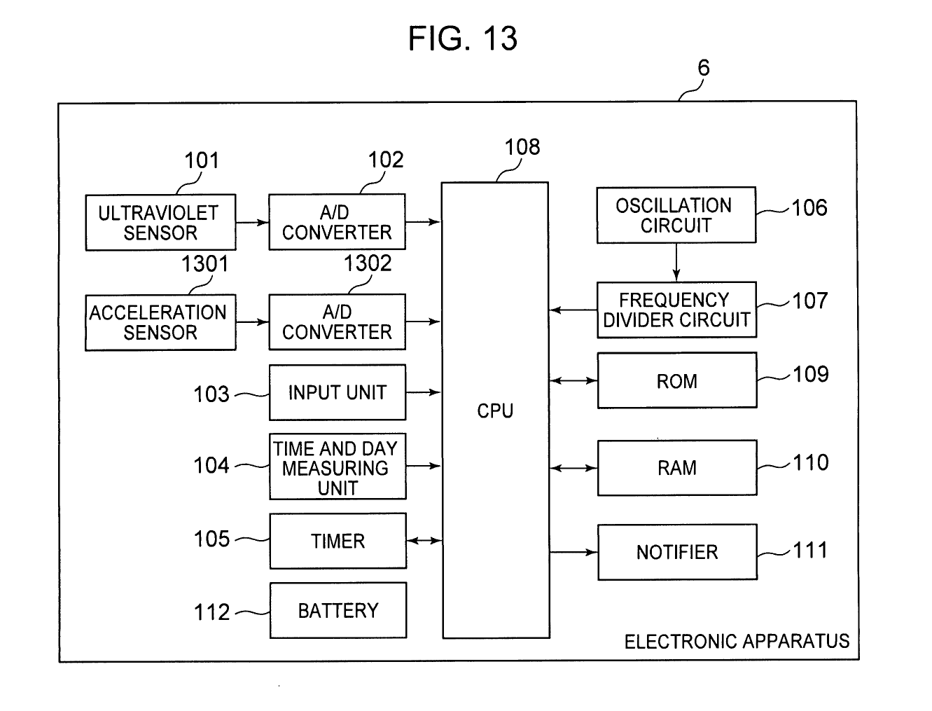

FIG. 13 is a schematic block diagram showing a configuration of a timepiece apparatus (referred to as timepiece apparatus 6) according to the sixth embodiment.

The timepiece apparatus 6 includes an acceleration sensor 1301 and an A/D converter 1302 in addition to the similar configuration as the timepiece apparatus 2 in the second embodiment.

The acceleration sensor 1301 generates an acceleration signal indicating acceleration caused by actions such as walking or running of the user. The acceleration sensor 1301 is a three-axis acceleration sensor which generates the acceleration signals along the directions of respective coordinate axes of x, y, and z, for example. The acceleration sensor 1301 outputs the generated acceleration signals to the A/D converter 1302.

The A/D converter 1302 generates digital acceleration signals by converting the acceleration signals supplied from the acceleration sensor 1301 from analogue to digital. The A/D converter 1302 outputs the generated digital acceleration signal to the CPU 108.

The CPU 108 detects the state of activity of the user on the basis of the digital acceleration signal received from the A/D converter 1302. The activity of the user means positive movement of part or the entire part of the user's body such as walking or running.

The CPU 108 calculates an index value indicating an intensity of the supplied digital acceleration signal and periodicity in order to detect the state of activity. The CPU 108 determines that the user is in the state of activity when the calculated index value is determined to be within a preset range.

The CPU 108 calculates, for example, a short time average power, as the index value indicating the intensity of the digital acceleration signal. The short time average power is an average power of a square value of the acceleration at preset time intervals (for example 20 ms). By calculating the short time average power, the CPU 108 can eliminate unreal components in the action of a person having a time period sufficiently shorter than the preset time intervals and detect the walking state accurately. The CPU 108 determines whether or not the calculated short time average power is within a range between preset upper limit and a lower limit of power. Accordingly, the CPU 108 is capable of determining whether or not the calculated short time average power is within a realistic range of the short time average power in the state in which the user is in activity (for example, 0.01 to 1.0 (m/s²)²).

The CPU 108 calculates, for example, a pitch period, as the index value indicating the periodicity of the digital acceleration signal. The pitch period is an inverse number of the number of steps per unit time. In order to calculate the pitch period, for example, the CPU 108 detects the period from a time point when an amplitude of the digital acceleration signal exceeds a threshold value of a preset amplitude until a time point when the amplitude of the digital acceleration signal exceeds the threshold value for the next time. The CPU 108 sets the detected period as the pitch period. The CPU 108 determines whether or not the detected pitch period is within a range between an upper limit and a lower limit of the preset pitch period. Accordingly, the CPU 108 is capable of determining whether or not the detected pitch period is within a realistic range of the pitch period in the state in which the user is in activity (for example, 0.5 to 2.0 (s)).

When it is determined that the user is in the state of activity, the CPU 108 calculates a value shortened by multiplying the preset sunburn preventing period by a preset coefficient smaller than “1” (for example 0.5) as the sunburn preventing period in the state of activity. The CPU 108 uses the sunburn preventing period calculated instead of the preset sunburn preventing period and performs an action (Steps S101 to S110) relating to the notification control shown in FIG. 3, for example.

Subsequently, an example of the operation of the CPU 108 (notification control apparatus) in the sixth embodiment will be described.

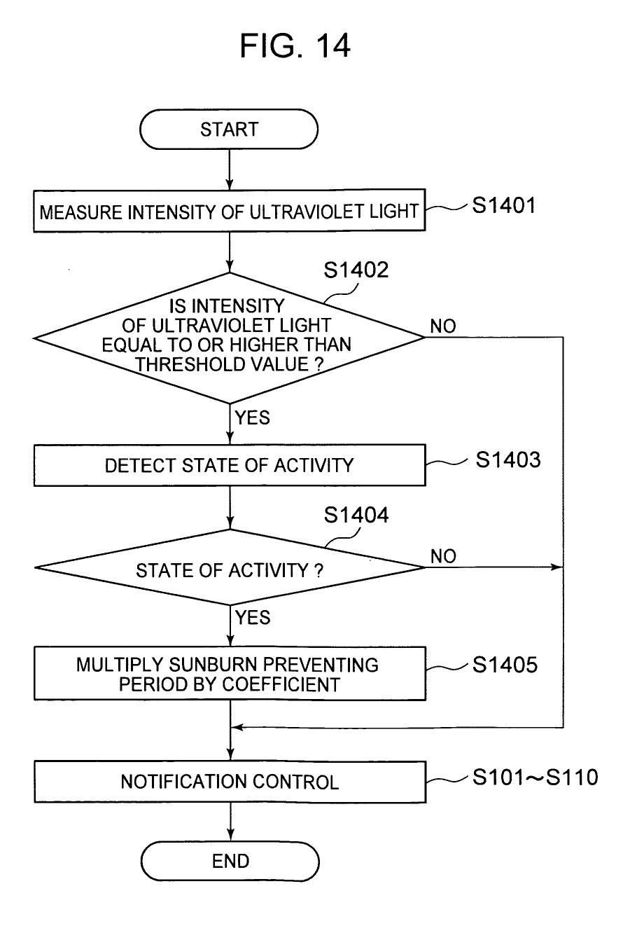

FIG. 14 is a flowchart showing an example of the operation of the CPU 108 in the sixth embodiment. The operation of the CPU 108 in the sixth embodiment includes Steps S1401 to S1405, and Steps S101 to S110 (Operation in the notification control) follows.

(Step S1401) The CPU 108 receives an input of the digital signal (intensity of ultraviolet light) after conversion from the A/D converter 102. Subsequently, the procedure goes to Step S1402. The A/D converter 102 receives an input of the analog signal indicating the intensity of ultraviolet light measured from the ultraviolet sensor 101.

(Step S1402) The CPU 108 determines whether or not the intensity of the ultraviolet light indicated by the received digital signal is equal to or higher than the threshold value of the preset intensity of the ultraviolet light. If the CPU 108 determines that the intensity of ultraviolet light indicated by the received digital signal is equal to or higher than the threshold value of the preset intensity of the ultraviolet light (Yes), the procedure goes to Step S1403. If the CPU 108 determines that the intensity of ultraviolet light indicated by the received digital signal is lower than the threshold value of the preset intensity of ultraviolet light (No), the procedure goes to Step S101.

(Step S1403) The CPU 108 calculates the index value on the basis of the digital acceleration signal received from the A/D converter 1302, and determines whether or not the user is in the state of activity depending on whether or not the calculated index value is within the preset range. Subsequently, the procedure goes to Step S1404.

(Step S1404) When the CPU 108 determines that the user is in the state of activity (Yes), the procedure goes to Step S1405. When the CPU 108 determines that the user is not in the state of activity (No), the procedure goes to Step S101.

(Step S1405) The CPU 108 calculates a value shortened by multiplying the preset sunburn preventing period by the preset coefficient smaller than “1” (for example 0.5) as the sunburn preventing period in the state of activity. Subsequently, the procedure goes to Step S101.

(Steps S101 to S110) The CPU 108 performs the operation relating to the notification control shown in FIG. 3 using the calculated sunburn preventing period or the preset sunburn preventing period. Then, the operation is ended.

When the user is in the state of activity, there is a case where the material for the sunburn preventing such as the sunburn preventing cream which covers the surface of the skin may come off due to the perspiration or the friction with the clothes. Accordingly, in the sixth embodiment, the timepiece apparatus 6 is capable of sensing the state of activity of the user and presenting information which prompts the user to take the sunburn preventing measure in a shorter time.

In this embodiment, the CPU 108 may be configured to set the range of the index value being different from one type of the state of activity to another (for example, walking, running) and determine the type of the state of activity on the basis of the index value on the basis of the received digital acceleration signal. In this case, the CPU 108 may set smaller coefficients for the more active state of activity in advance, and calculate the sunburn preventing period by multiplying the preset sunburn preventing period by the coefficient according to the determined state of activity. The term “active state of activity” means a state in which the number of steps is large or a state in which the short time average power is large as an index value. The CPU 108 performs the operation relating to the notification control shown in FIG. 3 using the calculated sunburn preventing period.

Accordingly, in the sixth embodiment, the timepiece apparatus 6 is capable of presenting information which prompts the user to take the sunburn preventing measure in shorter times as the activeness of the activity of the user is increased.

In the embodiments described above, a plurality of candidate values for the sunburn preventing period may be stored in the ROM 109 or the RAM 110 in advance. In this case, the CPU 108 reads out a candidate value from the ROM 109 or the RAM 110 and outputs the read-out candidate value to the notifier 111, and the notifier 111 displays the candidate value received from the CPU 108. The input unit 103 receives the operation of the user, and outputs a signal which indicates any one of the displayed candidate values in association with the received operation to the CPU 108. The CPU 108 sets the candidate value corresponding to the signal supplied from the notifier 111 as the sunburn preventing period, and uses the set sunburn preventing period for the notification control described above. Accordingly, adequate sunburn preventing periods can be selected from user to user.

All of, or part of functions of the respective components provided in the notification control apparatus in the respective embodiments described above may be implemented by recording a program for implementing these functions to a computer-readable recording medium to cause a computer system to read in the program recorded in the recording medium and executing the program. The term “computer system” mentioned here includes Operating System or Hardware such as computer peripherals.

The expression “computer-readable recording medium” includes portable media such as flexible disks, magneto-optical disks, ROMs, and CD-ROMS, and recording apparatuses such as hard disks integrated in the computer systems. In addition, the expression “computer-readable recording medium” may also include those which hold a program dynamically in a short time such as communication lines in a case of sending a program via networks such as internet or communication lines such as telephone lines, or those holding the program for a certain period such as servers in this case or a volatile memory in the computer system as a client. The above-described program may be intended to implement part of the above-described functions and, in addition, those which can implement the above-described function in combination with the program which is already recorded in the computer system.

Although the first embodiment to the sixth embodiment of the invention has been described in detail with reference to the drawings, the detailed configuration is not limited to those described above, and various modifications in designs may be made without departing from the scope of the invention.

What is claimed is:

1. A notification control apparatus comprising a notification controller configured to exercise control to prompt a user to perform a sunburn preventing treatment after an elapse of a first period and, after a second period has elapsed from the notification, notify the elapse of the second period.

2. The notification control apparatus according to claim 1, wherein the notification controller starts counting of the first period when there is an input indicating the fact that the sunburn preventing treatment has finished before the elapse of the second period.

3. The notification control apparatus according to claim 1, wherein a total period of the first period and the second period is a period until the preset sunburn preventing treatment loses its effect and the second period corresponds to a period spent for the sunburn preventing treatment.

4. The notification control apparatus according to claim 2, wherein a total period of the first period and the second period is a period until the preset sunburn preventing treatment loses its effect and the second period corresponds to a period spent for the sunburn preventing treatment.

5. The notification control apparatus according to claim 1, comprising an ultraviolet light detection controller configured to cause an intensity of ultraviolet light to be measured when the time indicated by a time and day measuring unit is within a preset range, wherein the notification controller controls to prompt the user to perform the sunburn preventing treatment when the intensity caused by the ultraviolet light detection controller to be measured is equal to or higher than a threshold value.

6. The notification control apparatus according to claim 2, comprising an ultraviolet light detection controller configured to cause an intensity of ultraviolet light to be measured when the time indicated by a time and day measuring unit is within a preset range, wherein the notification controller controls to prompt the user to perform the sunburn preventing treatment when the intensity caused by the ultraviolet light detection controller to be measured is equal to or higher than a threshold value.

7. The notification control apparatus according to claim 5, wherein the time within the preset range is a time when the user goes outdoors.

8. The notification control apparatus according to claim 6, wherein the time within the preset range is a time when the user goes outdoors.

9. The notification control apparatus according to claim 1, wherein the notification controller exercises control to prompt the user to perform the sunburn preventing treatment at a specified starting time and starts the measurement of the first period after the notification.

10. The notification control apparatus according to claim 2, wherein the notification controller exercises control to prompt the user to perform the sunburn preventing treatment at a specified starting time and starts the measurement of the first period after the notification.

11. The notification control apparatus according to claim 3, wherein the notification controller exercises control to prompt the user to perform the sunburn preventing treatment at a specified starting time and starts the measurement of the first period after the notification.

12. The notification control apparatus according to claim 4, wherein the notification controller exercises control to prompt the user to perform the sunburn preventing treatment at a specified starting time and starts the measurement of the first period after the notification.

13. The notification control apparatus according to claim 1, comprising an input controller configured to accept a first input indicating that the user has gone out to a place in the sun and a second input indicating that the user has entered a place out of the sun,
wherein the notification controller exercises control to prompt the user to perform the sunburn preventing treatment when the time elapsed from a moment when the input controller receives the second input is longer than the first period at the moment when the input controller receives the first input.

14. The notification control apparatus according to claim 1, comprising an ultraviolet light detection controller configured to cause the intensity of ultraviolet light to be measured when the first period has elapsed, wherein the notification controller determines a mode of prompting the user to perform the sunburn preventing treatment on the basis of the intensity of ultraviolet light measured by the ultraviolet light detection controller.

15. The notification control apparatus according to claim 1, comprising an ultraviolet light detection controller configured to cause an integrated quantity of ultraviolet light obtained by integrating the intensity of ultraviolet light until the first period is elapsed to be measured, wherein the notification controller determines a mode of prompting the user to perform the sunburn preventing treatment on the basis of the integrated quantity of ultraviolet light measured by the ultraviolet light detection controller.

16. The notification control apparatus according to claim 1, comprising an ultraviolet light detection controller configured to cause the integrated quantity of ultraviolet light obtained by integrating the intensity of ultraviolet light until the first period is elapsed to be measured, wherein the notification controller sets the first period on the basis of the integrated quantity of ultraviolet light measured by the ultraviolet light detection controller.

17. The notification control apparatus according to claim 1, comprising:
an ultraviolet detection controller configured to cause the intensity of ultraviolet light to be measured; and
a user detection controller configured to cause a state of activity of the user to be detected when the intensity caused by the ultraviolet light detection controller to be measured is equal to or higher than the threshold value,
wherein the notification controller shortens the first period on the basis of the detected state of activity.

18. An electronic apparatus comprising the notification control apparatus according to claim 1.

19. A timepiece apparatus comprising the notification control apparatus according to claim 1.

20. A program for causing a computer of a notification control apparatus to execute a procedure for exercising control for prompting a user to perform a sunburn preventing treatment after an elapse of a first period and notifying the elapse of a second period again after the elapse of the second period from the prompt.
